(19) United States
(12) Patent Application Publication
(10) Pub. No.: US 2016/0086134 A1
(43) Pub. Date: Mar. 24, 2016

(54) SYSTEM AND METHOD FOR IDENTIFYING HIGH VALUE CANDIDATES

(71) Applicant: Eric Schwab, Santa Monica, CA (US)

(72) Inventor: Eric Schwab, Santa Monica, CA (US)

(21) Appl. No.: 14/491,085

(22) Filed: Sep. 19, 2014

(51) Int. Cl. G06Q 10/10

(52) U.S. Cl. CPC G06Q 10/1053

(57) ABSTRACT

A system and method for identifying a high value target. The system is implemented via a computer running software with first code stored on a tangible medium for processing objective data regarding a candidate to provide a first metric; second code stored on said medium for processing subjective data regarding the candidate to provide a second metric; third code stored on said medium for processing test data generated by the candidate to provide a third metric; fourth code stored on said medium for combining the first, second and/or third metrics to generate a fourth metric relating to the suitability of the candidate as a high value target; a processor for executing said first, second, third and fourth code; and an apparatus coupled to the processor for outputting a score or recommendation relating to the candidate as a high value target. The inventive method for identifying a high value target includes the steps of: processing objective data regarding a candidate to provide a first metric; processing subjective data regarding the candidate to provide a second metric; processing test data generated by the candidate to provide a third metric; and combining the first, second and/or third metrics to generate a fourth metric relating to the suitability of the candidate as a high value target.

### BACKGROUND OF THE INVENTION

1. Field of the Invention

The present invention relates to computing systems. More specifically, the present invention relates to systems for identifying and targeting high value candidates.

2. Description of the Related Art

In many applications there is a need for a system capable of identifying a high value target or asset. For example, in employment applications, some employers seek an ‘A’ player, that is, an exceptional candidate. Conventional techniques for identifying the ‘A’ player include reviewing a large number of resumes, and/or interviewing a large number of candidates until an exceptional candidate is identified. This process is often facilitated by referrals from placement consultants and references from prior employers.

Unfortunately, it can be burdensome to search a large database in an attempt to find exceptional candidates, or to interview a large number of candidates. Placement consultants have a tendency to exaggerate the capabilities of candidates referred by their firms and candidates make prior employer references available only if they can be expected to be positive and, even then, such prior employers will often either express polite compliments or merely confirm employment. In certain circumstances, such as employment opportunities requiring substantial technical expertise, the placement consultant and other individuals involved in the recruiting and evaluation process may not have sufficient technical knowledge to efficiently or reliably ascertain a candidate's level of skill. Hence, the approach to finding the ‘A’ player has proven to be time-consuming, inefficient and somewhat unreliable.

Accordingly, a need remains in the art for a system for identifying and targeting high value candidates.

### SUMMARY OF THE INVENTION

The need in the art is addressed by the system and method of the present invention for identifying a high value target. The system is implemented via a computer running software with first code stored on a tangible medium for processing objective data regarding a candidate to provide a first metric; second code stored on said medium for processing subjective data regarding the candidate to provide a second metric; third code stored on said medium for processing test data generated by the candidate to provide a third metric; fourth code stored on said medium for combining the first, second and/or third metrics to generate a fourth metric relating to the suitability of the candidate as a high value target; a processor for executing said first, second, third and fourth code; and an apparatus coupled to the processor for outputting a score or recommendation relating to the candidate as a high value target. The inventive method for identifying a high value target includes the steps of: processing objective data regarding a candidate to provide a first metric; processing subjective data regarding the candidate to provide a second metric; processing test data generated by the candidate to provide a third metric; and combining the first, second and/or third metrics to generate a fourth metric relating to the suitability of the candidate as a high value target.

### BRIEF DESCRIPTION OF THE DRAWINGS

FIG. 1 is a diagram illustrative of the operational ecosystem of the system for identifying a high value target candidate of the present invention.

FIG. 2 is a flow diagram of the method for identifying a high value target candidate of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

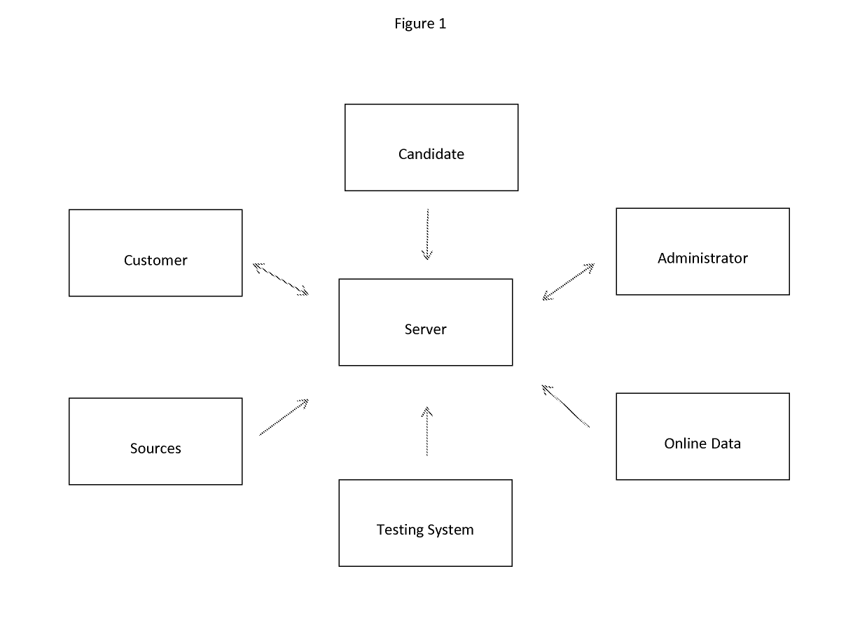

FIG. 1 is a diagram illustrative of the operational ecosystem of the system for identifying a high value target candidate of the present invention. As illustrated in FIG. 1, the system includes a server that processes software stored on a tangible medium connected to a network such as the Internet, along with inputs from numerous sources, and outputs a rating for a candidate. The server runs software with first code stored on a tangible medium (not shown) for processing objective data regarding a candidate to provide a first metric; second code stored on the medium for processing subjective data regarding the candidate to provide a second metric; third code stored on the medium for processing test data generated by the candidate to provide a third metric; fourth code stored on said medium for combining the first, second and/or third metrics to generate a fourth metric relating to the suitability of the candidate as a high value target; a processor (not shown) for executing said first, second, third and fourth code; and an apparatus (not shown) coupled to the processor for outputting a score or recommendation relating to the candidate as a high value target.

In the illustrative embodiment, the system creates a database of potential candidates; collects and processes objective and subjective information about each candidate; conducts testing of candidates; calculates a rating for each candidate based on objective, subjective, and test data; solicits information on opportunities for high-value targets; evaluates the suitability of each candidate for those opportunities based on the calculated ratings and other factors; and updates its recommendations on an ongoing basis with the availability of new data about each candidate.

The inventive system can be used in many applications, including by way of example and without limitation, personnel recruiting, product reviews, merchant evaluations, ratings of service providers, etc. In each of these examples, individuals or organizations can make better decisions based on the rating or recommendation provided by the system. Personnel, service providers, merchants, and others can participate in the system to receive a rating or recommendation in a variety of ways. For example, in a recruiting application, in accordance with the present teachings, candidates may be invited to participate in the system through administrator requests, advertising, peer referrals, or other means. See copending U.S. Patent Application entitled ______, filed ______ by E. Schwab, (Attorney Docket no. Schwab-2) the teachings of which are hereby incorporated herein by reference.

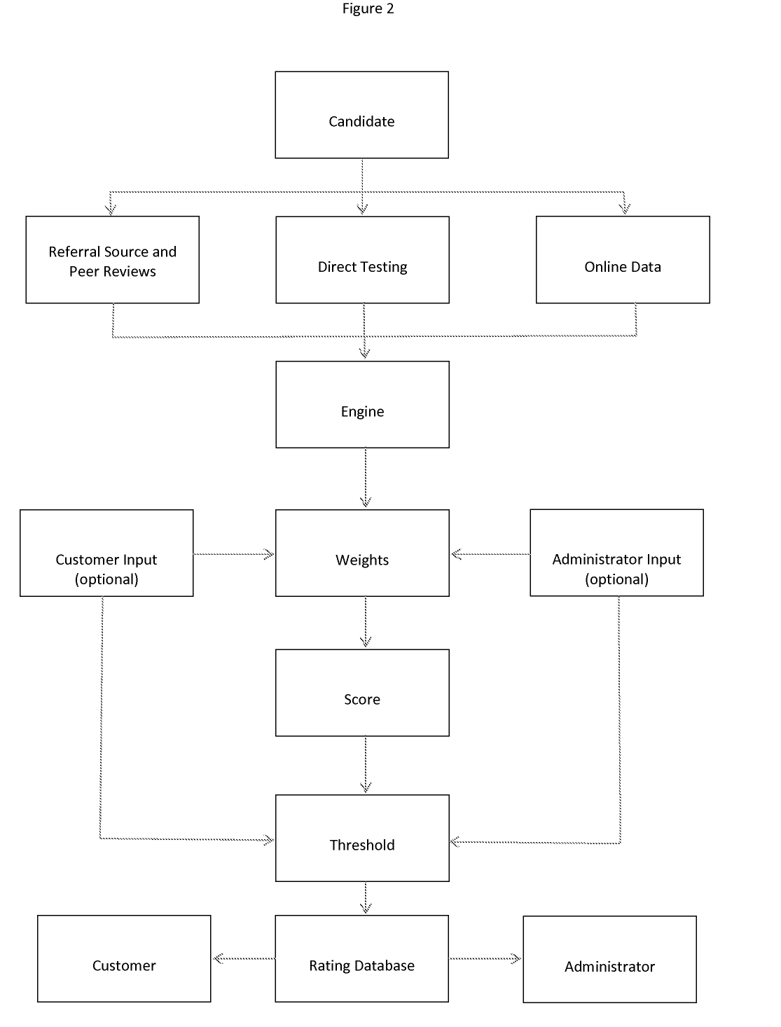

FIG. 2 shows a flow diagram of the method for identifying a high value target candidate of the present invention. The candidate, or an individual acting on the candidate's behalf, provides information to the system including the candidate's geographical location, educational background, employment history, area(s) of focus, length of experience with each area, professional certifications, and/or other objective data.

To validate the accuracy of the objective data, the system conducts queries to public and/or private data sources. A person skilled in the art can readily observe that the Internet is a primary though not necessarily exclusive source for such data. The validated objective information is given a weight in accordance with its importance in establishing the strength of the candidate. For example, a degree in computer science from a respected university may have more weight for a software engineer than would a certification for a one-week vendor-sponsored seminar. Additionally, the calculated accuracy of the objective data provided by the candidate—in other words, the apparent truthfulness of the candidate—is incorporated in calculating a metric that represents the objective data's indication that a candidate is indeed a high-value target. A simplified formula to express this calculation follows:

Score=([ObjectiveData1]*[ObjectiveData1Importance])+([ObjectiveData2]*[ObjectiveData2Importance])+([ObjectiveData(n)]*[ObjectiveData(n)Importance])+(([ObjectiveData(n)Verified]/(ObjectiveData(n)Invalidated))*[ImportanceofAccuracy])

. . . where ObjectiveData[x] reflects the particular fact being assessed, the ObjectiveData[x]Importance is an integer reflecting the weight to be given to that credential, the ObjectiveData(n)Verified represents the number of objective facts provided by the candidate and validated by the system, the ObjectiveData(n)Invalidated represents the number of objective facts provided by the candidate that were proven false by the system, and the ImportanceofAccuracy represents an integer reflecting the weight given to the system for the candidate's apparent veracity.

While many existing human resources software applications attempt to match candidates and opportunities based on information such as geographic location, area(s) of expertise, experience level, keywords, and other objective data, by itself this objective data provides only modest value in identifying a high-value target. In addition to this objective data, in accordance with the present teachings, the inventive system collects and processes a variety of subjective data about each candidate. This includes the original referral source for each candidate, which source may or may not have already been identified as a high-value individual itself, or as a source for other high-value individuals. Additionally, the system invites each candidate to solicit feedback from present or past employers, peers, and/or other sources. These sources in turn are asked to provide subjective ratings of the candidate, via the present system. The system stores these ratings, as well as a history of the ratings given by each of these sources to one or more candidates within the database. The subjective data related to any candidates is likely to evolve and candidates may invite third parties to provide testimonials and/or to participate in rating the candidate at any time.

In addition to processing objective and subjective data, the present system may invite each candidate to participate in testing. Candidates who choose to participate are presented with a series of tests and exercises, including knowledge-based tests, task-based tests, and reasoning tests. In the illustrative embodiment, candidates typically interact with the system for these tests through communication over the Internet, although the testing could be conducted through a variety of electronic means. The tests may be provided by an employer based on the requirements for a given position or by a human resource expert without departing from the scope of the present teachings.

Knowledge-based tests consist of predefined fact-based questions, e.g., “What's the square root of 100?” The system displays questions individually, with an imposed time limit for all answers, as a means to increase the probability that candidates provide an answer without conducting contemporaneous research during the testing. The system records the candidate's answers as well as the timing of their responses.

Task-based tests direct candidates to answer how they would accomplish a particular task, e.g. “When building a new house, in what order would you handle the following tasks: electrical work, foundation, painting, and framing?” The system records the candidate's answers as well as the timing of their responses.

Reasoning tests are exercises designed to assess a candidate's logical reasoning skills and/or creativity given a hypothetical scenario. The questions require inductive and/or deductive reasoning, with a subset of questions testing a candidate's creative problem-solving skills.

The system evaluates a candidate's responses by comparing their answers to fact-based questions with known answers. For questions without precise pre-defined answers, such as those involving problem-solving skills, the system evaluates a candidate's response by administrator review and/or by comparison of the candidate's answers to the submissions of other candidates who are judged by the system to be high-value targets. Should there be an insufficient quantity of such responses to judge the candidate's response, the system may invite administrators and/or other candidates to anonymously rate the responses. The system assigns weights to those ratings based on the skill, experience level, and assessed ratings of each of the respondents. Those ratings are then combined into a weighted average, to assess the quality of the candidate's response to a given question.

The system calculates a metric or score given the accuracy of the candidate's responses to all questions. Each response may be given a different weight, in accordance with the complexity of the system and the importance of that question in evaluating whether a candidate is likely a high-value target in his or her area of skill.

The system uses individual metrics related to the objective data, subjective data, and test results of each candidate, within an overall classification method designed to separate high-value individuals from other candidates. The classification is designed to be relative rather than universal; each candidate is evaluated relative to other individuals with a similar area of expertise, at a similar stage of their career, located in a similar geography, and/or other factors. In embodiments of the invention other than personnel recruitment, the system uses a similar process to discern from objective and subjective data, a classification that is relative to other individuals or entities.

The system calculates each individual metric through an algorithm that incorporates the weight given to each individual source of information. As a simplified example, a score for the subjective data may be calculated as:

Score=([ReferralSourceTrustLevel]*2.5)+([Peer1Review]*[Peer1TrustLevel])+([Peer(n)Review]*[Peer(n)TrustLevel])+([Company1Feedback]*[Company1TrustLevel])+([Company(n)Feedback]*[Company(n)TrustLevel]) [1]

. . . where a relative weight (of 2.5 in this example) is given to the original referral source of the candidate, the Peer[n]Review is an integer reflecting the overall assessment made of the candidate by the peer conducting the review, the Peer[n]TrustLevel is an integer reflecting the level of trust given by the system to that particular peer, Company[n]Feedback is an integer reflecting the overall assessment made of the candidate by a company that has communicated with the candidate, and Company [n]TrustLevel is an integer reflecting the level of trust given by the system to that particular company. In the application, the formula may include additional calculations to reflect the relative weights of peer reviews, feedback, and other subjective criteria.

The system calculates an overall rating for a candidate incorporating the subjective, objective, and test data metrics, with a weight assigned to each of those areas:

Overall Rating=(metric from objective data*weight for objective data)+(metric from subjective data*weight for subjective data)+(metric from test data*weight for test data) [2]

One skilled in the art would recognize that the weights for the different elements used in the overall candidate rating may change over time, with the same essential algorithm without departing from the scope of the present teachings.

The overall rating is used as the basis for the classification of a candidate as a high-value individual. The system may provide an indication of its confidence level for a particular classification (e.g. an “A” player), based on the current rating for the candidate. For example, a candidate with an overall rating of 220 may be considered an “A” player with a high level of confidence, whereas a candidate with an overall rating of 190 may be considered an “A” player but with only a modest level of confidence, and a candidate with an overall rating of 150 may not be considered an “A” player.

The system updates the ratings for candidates based on additional information, including new subjective data such as ratings from peers or feedback from companies that interact with candidates.

Thus, the inventive method for identifying a high value target includes the steps of: processing objective data regarding a candidate to provide a first metric; processing subjective data regarding the candidate to provide a second metric; processing test data generated by the candidate to provide a third metric; and combining the first, second and/or third metrics to generate a fourth metric relating to the suitability of the candidate as a high value target. One skilled in the art can appreciate that the system will work in the absence of one or more of these elements.

Companies seeking one or more high-value candidates may use the system to discover or recruit appropriate individuals for a particular job or opportunity. Such corporate customers or other administrators can specify any minimum rating a candidate must have (e.g. a threshold) in order to view and/or respond to the opportunity. The customer or administrator also provides various objective criteria related to the opportunity, including its geographic location, the skill(s) required, the experience level required, and other details as may typically be included in a job description. The customer or administrator may choose to limit an opportunity such that it is only visible to candidates with certain ratings, skills, and/or other criteria.

The administrator or customer may also optionally provide test questions relevant to the opportunity. Candidates interested in the opportunity must answer those questions; candidates may be required to meet or exceed a minimum threshold score in their responses to those questions, in order to be able to view further details on, and/or apply for, the opportunity.

Once a job or opportunity is added to the system, the system matches opportunities and qualifying candidates. In determining appropriate matches, the system compares criteria specified for the opportunity—including required area(s) of expertise, experience level necessary, geographical requirements, and so forth—with relevant data for each candidate. In addition to this algorithm traditionally used in candidate searches, the system applies a filter to only include candidates whose overall ratings meet or exceed the minimum rating/confidence level required by the opportunity.

The system communicates information about matching candidates to an administrator and/or to customers, subject to the preferences of the candidates. Information provided to customers may be limited to only matching candidates and/or only candidates who have expressed an interest in the opportunity and who would like to be contacted.

The system notifies matching candidates of available opportunities, subject to candidate preferences. The information regarding each opportunity may be provided only in limited form, or not provided at all, to candidates who do not meet the minimum rating threshold required by the customer.

Candidates may respond to one or more opportunities, and may participate in job-specific online testing encompassing the questions associated with a given opportunity. After communicating with a candidate, a company may provide additional feedback on that candidate to the system, as another source of subjective data about that candidate that the system will incorporate in subsequent ratings calculations.

The system periodically updates candidate ratings based on the latest objective, subjective, and testing data. Similarly, the system regularly updates the matching candidates for each opportunity, given the addition of new candidates, the addition of new opportunities, and changes to the ratings for the candidates within the system.

Thus, the inventive system has been disclosed that includes first means for processing objective data regarding a candidate to provide a first metric; second means for processing subjective data regarding the candidate to provide a second metric; third means for processing test data generated by the candidate to provide a third metric; and fourth means for combining the first, second and/or third metrics to generate a fourth metric relating to the suitability of the candidate as a high value target. In a specific embodiment, the first means includes means for sampling a database regarding the candidate. In the illustrative embodiment, the sampling operation would include a review of objective data—e.g. verification of birth date, educational degree, employment history, certifications achieved, etc.—along with information that the system would glean from public sources including the Internet, and/or private databases. The second means includes means for sampling opinions of individuals regarding the candidate. As noted above, the referral source, e.g. an implied bit of subjective data, may also be used for this purpose. The third means includes means for administering one or more tests to the candidate. The fourth means uses customizable algorithms that combine the results of one or more of the first, second, and third metrics, with weights assigned to each metric by an administrator, to calculate an overall ratings metric for a candidate. The fourth means includes means for comparing the fourth metric to a threshold. In the process, the inventive system automatically processes data from a variety of sources, transforms it into a rating for a candidate and outputs the rating on a display such as a computer monitor. As mentioned above, the system may be implemented via software, stored on a physical tangible medium such as a disk drive or solid state array, executed by a processor in the server of FIG. 1.

The system could be implemented in one system or hundreds of systems. While the use of multiple physical systems can provide greater scalability and other advantages, the physical components of the system can readily change and the architecture of the system is best described as a logical system. Abstracted from physical systems, the logical system includes individual components that:
collect inputs (candidate information, opportunity information, subjective data, feedback from companies, etc.);
query 3^{rd}-party data (Internet sources, public/private databases, etc.);
conduct testing;
perform calculations (determine trust in sources; calculate objective/subjective/test/overall scores, etc.); and
perform output (classifications, confidence levels, etc.).

The present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A system for identifying a high value target comprising:
first code stored on a tangible medium for processing objective data regarding a candidate to provide a first metric;
second code stored on said medium for processing subjective data regarding the candidate to provide a second metric, said second code includes code for evaluating or rating a referral source regarding the candidate;
third code stored on said medium for processing text data generated by the candidate to provide a third metric;
fourth code stored on said medium for combining the first, second, and third metrics to generate a fourth metric relating to the suitability of the candidate as a high value target, said fourth code including code for comparing the fourth metric to a threshold;
a processor for executing said first, second, third and fourth code; and
an apparatus coupled to the processor for outputting a score of recommendation relating to said candidate or said high value target.

2. The invention of claim 1 wherein the first code includes code for sampling one or more databases regarding the candidate.

3. The invention of claim 2 wherein the database shall include the Internet and other data sources.

4. The invention of claim 1 wherein the second code includes code for sampling opinions of individuals regarding the candidate.

5. (canceled)

6. The invention of claim 1 wherein the third code includes for administering one or more tests to the candidate.

7. The invention of claim 1 wherein said fourth code uses the formula (rating from objective data*weight for objective data)+(rating from subjective data*weight for subjective data)+(rating from test data*weight for test data)=overall rating.

8. The invention of claim 7 wherein the ratings are the metrics derived from the code for processing objective data, subjective data, and test data

9. The invention of claim 8 wherein the weights are input by an administrator or a third party.

10. The invention of claim 9 wherein the third party is a customer.

11. (canceled)

12. (canceled)

13. A method for identifying a high value target comprising the steps of:
processing objective data regarding a candidate to provide a first metric;
processing subjective data regarding the candidate to provide a second metric;
processing test data generated by the candidate to provide a third metric; and
combining the first, second and/or third metrics to generate a fourth metric relating to the suitability of the candidate as a high value target.

14. A method for testing an individual comprising the steps of:
directing the candidate to authenticate his or her identity, if he or she has not yet done so directing the candidate to respond to one or more queries encompassing fact-based questions, process-related questions, and reasoning tests;
time-limiting responses to questions, and recording the response times;
comparing responses for fact-based questions to known answers;
comparing responses for process-based questions to known best practices;
comparing responses for reasoning tests to answers from other individuals;
soliciting a review of a candidate's responses by other candidates; and
determining a metric for reasoning test results based on comparisons of a candidate's responses to responses from other candidates, reviews from other candidates, and the trust given to those other candidates.

15. A method for validating responses to online testing comprising the steps of:
directing the candidate to authenticate his or her identity before proceeding with testing;
directing the candidate to respond, via an Internet-connected device, to one or more questions concerning facts or generally accepted best practices;
displaying one question at a time;
time-limiting responses to each question by withdrawing a question and replacing that question with an alternative question, if the candidate has not responded within a designated time interval;
ending the testing if the candidate does not respond to a set number of sequential test questions;
recording the response times for each question; and
determining a metric for the candidate's test results, based on the accuracy of the answers and the speed of the responses.

16. A method for identifying a high value candidate comprising the steps of:
defining a threshold at which a target may be classified as high value;
compiling subjective reviews regarding that target from a variety of sources; and
assigning a weight to each source based on a level of trust in the source.

17. The invention of claim 16 wherein the trust is based on administrator input and on the experience with other behavior from that source.

18. The invention of claim 17 including the step of calculating an overall metric reflecting the value or classification of the target, based on a weighted average of the subjective data.

19. The invention of claim 16 further including the step of adding a confidence level in the classification.

20. The invention of claim 19 wherein the confidence level is based, at least in part, on the number of subjective sources.

21. The invention of claim 19 wherein the confidence level is based, at least in part, on the degree of trust in each of the sources.

22. The invention of claim 19 wherein the confidence level is based, at least in part, on the ratio of known to previously unknown sources.

23. The invention of claim 19 including the step of evaluating or rating a referral source regarding the candidate.

24. A system for identifying a high value target comprising:
first means for processing objective data regarding a candidate to provide a first metric;
second means for processing subjective data regarding the candidate to provide a second metric; and
third means for combining the first and second metrics to generate a third metric relating to the suitability of the candidate as a high value target.

25. A system for identifying a high value target comprising:
first means for processing objective data regarding a candidate to provide a first metric;
second means for processing test data generated by the candidate to provide a second metric; and
third means for combining the first and second metrics to generate a third metric relating to the suitability of the candidate as a high value target.

26. A system for identifying a high value target comprising:
first means for processing subjective data regarding the candidate to provide a first metric;
second means for processing test data generated by the candidate to provide a second metric; and
third means for combining the first and second metrics to generate a third metric relating to the suitability of the candidate as a high value target.
